(19) United States
(12) Patent Application Publication
(10) Pub. No.: US 2025/0383543 A1
(43) Pub. Date: Dec. 18, 2025

(54) DISPLAY SYSTEM

(71) Applicant: Panasonic Automotive Systems Co., Ltd., Kanagawa (JP)

(72) Inventors: Kenji NAGATOMI, Osaka (JP); Norihiro IMAMURA, Osaka (JP); Michihiro YAMAGATA, Osaka (JP); Keiichi MATSUZAKI, Kyoto (JP); Yusuke NIHEI, Tokyo (JP)

(73) Assignee: Panasonic Automotive Systems Co., Ltd., Kanagawa (JP)

(21) Appl. No.: 19/230,825

(22) Filed: Jun. 6, 2025

(30) Foreign Application Priority Data
Jun. 14, 2024 (JP) 2024-096394

(51) Int. Cl. G02B 27/01; B60K 35/23

(52) U.S. Cl. CPC G02B 27/0101; B60K 35/23

(57) ABSTRACT

A display system includes a display device that projects first image light forming a first virtual image and second image light forming a second virtual image, a controller that controls the display device, and a reflective member that reflects the first image light and the second image light, the reflective member positioning the first virtual image and the second virtual image ahead of a user and ahead of the reflective member. In the reflective member, a reflectance of a first reflective region that reflects the first image light and a reflectance of a second reflective region that reflects the second image light differ from each other.

### CROSS REFERENCE TO RELATED APPLICATION

The present application is based on and claims priority of Japanese Patent Application No. 2024-096394 filed on Jun. 14, 2024.

### FIELD The present disclosure relates to a display system.

### BACKGROUND

Patent Literature (PTL) 1 discloses a head-up display that displays two virtual images ahead of the user. Specifically, one of the virtual images is positioned ahead of an optical member that is placed ahead of the user, and the other virtual image is positioned between the user and the optical member.

### CITATION LIST

### Patent Literature

PTL 1: International Patent Publication No. WO2021/095817.

### SUMMARY

However, the display system above can be improved upon.

In view of this, the present disclosure aims to improve upon the above related art.

A display system according to one aspect of the present disclosure includes: a display device that projects first image light forming a first virtual image and second image light forming a second virtual image; a controller that controls the display device; and a reflective member that reflects the first image light and the second image light, the reflective member positioning the first virtual image and the second virtual image ahead of a user and ahead of the reflective member, wherein in the reflective member, a reflectance of a first reflective region that reflects the first image light and a reflectance of a second reflective region that reflects the second image light differ from each other.

The display system according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram showing, in a side view, a state in which a display system according to Embodiment 1 is provided in a vehicle.

FIG. 2 is a sectional view showing, in an enlarged view, a surface structure of a part of a reflective member according to Embodiment 1.

FIG. 3 is a plan view showing an example of how a first reflective region and a second reflective region are arranged according to Embodiment 1.

FIG. 4 is a schematic sectional view showing a first display unit according to Embodiment 1.

FIG. 5 is a schematic sectional view showing a second display unit according to Embodiment 1.

FIG. 6 is an explanatory drawing showing an example of how a first virtual image and a second virtual image are displayed according to Embodiment 1.

FIG. 7 is a schematic diagram showing a display system according to Embodiment 2.

FIG. 8 is a schematic diagram showing a display system according to Embodiment 2.

FIG. 9 is an explanatory drawing showing an example of how a first virtual image and a second virtual image are displayed according to Embodiment 3.

FIG. 10 is an explanatory drawing showing a reflective member according to Embodiment 4.

FIG. 11 is an explanatory drawing showing a reflective member according to Embodiment 4.

FIG. 12 is an explanatory drawing showing a first display unit and a reflective member according to Embodiment 5.

FIG. 13 is an explanatory drawing showing a first display unit and a reflective member according to Embodiment 5.

FIG. 14 is a plan view showing a reflective member according to Embodiment 6.

FIG. 15 is an explanatory drawing showing a display device according to Embodiment 7.

FIG. 16 is an explanatory drawing showing a display device and a reflective member according to Embodiment 8.

FIG. 17 is an explanatory drawing showing a display device according to Embodiment 9.

FIG. 18 is an explanatory drawing showing a display device according to Embodiment 10.

FIG. 19 is an explanatory drawing showing a display device and a reflective member according to Embodiment 11.

FIG. 20 is an explanatory drawing showing a display device according to Embodiment 12.

### DESCRIPTION OF EMBODIMENTS

### Underlying Knowledge Forming Basis of the Present Disclosure

In recent years, there has been a demand to reduce the stress a user experiences when he or she looks at and recognizes separate virtual images. In other words, the present disclosure provides a display system that can reduce the stress a user experiences when he or she looks at and recognizes separate virtual images.

A display system according to one aspect of the present disclosure includes: a display device that projects first image light forming a first virtual image and second image light forming a second virtual image; a controller that controls the display device; and a reflective member that reflects the first image light and the second image light, the reflective member positioning the first virtual image and the second virtual image ahead of a user and ahead of the reflective member, wherein in the reflective member, a reflectance of a first reflective region that reflects the first image light and a reflectance of a second reflective region that reflects the second image light differ from each other.

According to this configuration, since the first virtual image and the second virtual image are positioned ahead of the user and ahead of the reflective member by the reflective member, the user's effort to adjust the focus when his or her gaze moves between the first virtual image and the second virtual image can be reduced. Accordingly, the stress that the user experiences when looking at and recognizing the first virtual image and the second virtual image can be reduced.

Furthermore, since the first virtual image and the second virtual image can be positioned at their respective predetermined positions with the use of the single reflective member, the entire system can be reduced in size. Since the first reflective region and the second reflective region of the reflective member have different reflectances, the first reflective region can be assigned a reflectance suitable for the first virtual image, and the second reflective region can be assigned a reflectance suitable for the second virtual image. Accordingly, the first virtual image and the second virtual image can each be displayed in a well-fitted manner.

Furthermore, the first reflective region may be disposed above the second reflective region.

According to this configuration, since the first reflective region is positioned above the second reflective region, the first virtual image and the second virtual image can be positioned next to each other in the up-down direction. In other words, the first virtual image and the second virtual image, when viewed as a whole, form a virtual image divided in the horizontal direction, and such a virtual image can be visually recognized easily by the user.

Furthermore, the reflectance of the first reflective region may be lower than the reflectance of the second reflective region.

According to this configuration, since the reflectance of the first reflective region located above the second reflective region is lower than the reflectance of the second reflective region, the first virtual image can be made less noticeable than the second virtual image. Accordingly, the first virtual image that more easily enters the user's view when he or she looks ahead is less likely to hinder the user's visibility ahead.

Furthermore, at least one of the reflectance of the first reflective region or the reflectance of the second reflective region may be variable.

According to this configuration, since at least one of the reflectance of the first reflective region or the reflectance of the second reflective region is variable, the reflectance of the first reflective region and the reflectance of the second reflective region can be adjusted, for example, in accordance with the circumstances surrounding the user. Accordingly, the first virtual image and the second virtual image can be displayed in a well-fitted manner in accordance with the surrounding circumstances.

Furthermore, the controller may include an equalizing mode that causes the reflectance of the first reflective region and the reflectance of the second reflective region to coincide with each other.

According to this configuration, since the reflectance of the first reflective region and the reflectance of the second reflective region are made to coincide with each other upon the equalizing mode being executed, the display state of the first virtual image and the display state of the second virtual image can be made to coincide with each other. With this configuration, when, for example, the user does not need to pay close attention to what lies ahead of the vehicle (during self-driving or when parking), content information can be displayed broadly by the first virtual image and the second virtual image.

Furthermore, the display device may include two display elements that each form image light of a different polarization, and when the equalizing mode is being executed, the controller, by controlling the display device, may cause image light to be projected from only one of the two display elements toward the first reflective region and the second reflective region.

According to this configuration, since, when the equalizing mode is being executed, the image light is projected from only one of the display elements onto the first reflective region and the second reflective region, the image qualities of the first virtual image and the second virtual image can be made to coincide with each other.

Furthermore, the reflective member may include a plurality of unit regions arrayed in a regular pattern, and reflectances of the plurality of unit regions may be variable independently of each other.

According to this configuration, since the reflectance of each of the unit regions of the reflective member is variable independently of each other, the size of the first reflective region and the second reflective region can be adjusted by varying the reflectance of each of the unit regions. Accordingly, the sizes, the positions, and so forth of the first virtual image and the second virtual image can be adjusted.

Furthermore, the display system may further include an estimator that estimates a viewpoint position of the user, wherein the controller may vary the reflectances of the plurality of unit regions based on the viewpoint position estimated by the estimator.

According to this configuration, since the controller varies the reflectances of the plurality of unit regions based on the viewpoint position estimated by the estimator, the sizes of the first reflective region and the second reflective region can be adjusted in accordance with the viewpoint position of the user.

Furthermore, the display system may further include at least one optical element for forming the first image light and the second image light, wherein based on the viewpoint position estimated by the estimator, the controller may make an adjustment to directions of the first image light and the second image light by changing an orientation of the at least one optical element, and vary the reflectances of the plurality of unit regions in accordance with the adjustment.

According to this configuration, based on the viewpoint position estimated by the estimator, the controller makes an adjustment to the directions of the first image light and the second image light by changing the orientation of the at least one optical element, and varies the reflectances of the plurality of unit regions in accordance with the adjustment. With this adjustment, the directions of the first image light and the second image light are adjusted in accordance with the position of the user's viewpoint, and in following this adjustment, the sizes of the first reflective region and the second reflective region are also adjusted.

Furthermore, the display device may include a first display element that forms the first image light, and a second display element that forms the second image light.

According to this configuration, since the first display element that forms the first image light and the second display element that forms the second image light are provided, this configuration makes it possible to control the first display element and the second display element independently of each other. Accordingly, the first virtual image formed by the first image light and the second virtual image formed by the second image light can be controlled independently of each other easily.

Furthermore, the display device may include a display element that forms the first image light and the second image light.

According to this configuration, since both the first image light and the second image light are formed by a single display element, the size of the display device can be reduced, as compared to the case in which dedicated display elements are provided separately.

Furthermore, the display element may be a liquid crystal panel, and the display device may include a first backlight that faces a first region of the liquid crystal panel where the liquid crystal panel forms the first image light, and a second backlight that faces a second region of the liquid crystal panel where the liquid crystal panel forms the second image light.

According to this configuration, since the first backlight and the second backlight are provided, a backlight suitable for each image light can be installed. Thus, the amount of heat emitted from each backlight can be reduced.

Furthermore, the display element may be curved.

According to this configuration, since the display element is curved, distortion of the first virtual image and the second virtual image can be reduced.

Furthermore, the reflective member may be a transparent member.

According to this configuration, since the reflective member is a transparent member, the reflective member can be kept from interfering with the user's view ahead.

Furthermore, the reflective member may be a windshield included in a vehicle.

According to this configuration, since the windshield included in the vehicle is used as the reflective member, this configuration renders it unnecessary to provide a dedicated reflective member, and the size of the display system can be reduced.

Furthermore, the first reflective region and the second reflective region may be at different inclinations, as viewed in side view.

According to this configuration, since the first reflective region and the second reflective region are at different inclinations, as viewed in side view, the flexibility of the layout of a first set of optical members that forms the optical path of the first image light and a second set of optical members that forms the optical path of the second image light can be increased.

Furthermore, the first virtual image and the second virtual image may be positioned with an interval of no more than 2 diopters, as viewed in side view.

According to this configuration, since the first virtual image and the second virtual image are positioned with an interval of no more than 2 diopters, as viewed in side view, the user's effort to adjust the focus when his or her gaze moves between the first virtual image and the second virtual image can be further reduced. Accordingly, the stress that the user experiences when looking at and recognizing the first virtual image and the second virtual image can be further reduced.

Furthermore, the first virtual image and the second virtual image may be positioned with an interval of 8 meters or more, as viewed in side view.

According to this configuration, since the first virtual image and the second virtual image are positioned with an interval of 10 meters or more, as viewed in side view, the first virtual image and the second virtual image can be displayed in accordance with the actual position of an object.

Furthermore, at least one of the first reflective region or the second reflective region of the reflective member may be laminated with a reflective film including at least one layer.

According to this configuration, adjusting the layer structure (the number of layers, the materials, etc.) of the reflective film on at least one of the first reflective region or the second reflective region makes it possible to increase the design flexibility of the reflectance or the reflection spectrum of at least one of the first reflective region or the second reflective region.

Furthermore, a mark to be displayed over the first virtual image and the second virtual image may be formed continuously in the first virtual image and the second virtual image.

According to this configuration, since the mark is formed continuously over the first virtual image and the second virtual image, the user's gaze can be guided between the first virtual image and the second virtual image based on the displayed mark.

Furthermore, the reflectance of the first reflective region may be lower than the reflectance of the second reflective region, the first virtual image may display first information, and the second virtual image may display second information having a larger amount of information than the first information.

According to this configuration, the second reflective region having a higher reflectance than the first reflective region reflects the second image light to project the second virtual image. Although the second virtual image presents the second information with a larger amount of information than the first information, since the second virtual image is formed by the light reflected by the second reflective region, the second information can be displayed clearly.

### EMBODIMENTS

Hereinafter, some embodiments will be described in specific terms with reference to the drawings. It is to be noted that the embodiments described hereinafter all illustrate specific examples of the present disclosure. The numerical values, the shapes, the materials, the constituent elements, the arrangement positions and the connection modes of the constituent elements, the steps, the order of the steps, and so on illustrated according to the following embodiments are all examples and are not intended to limit the present disclosure. Furthermore, among the constituent elements described according to the following embodiments, any constituent elements that are not cited in the independent claims expressing the broadest concept are to be construed as optional constituent elements.

In the following description of the embodiments, terms, such as “parallel” and “orthogonal”, that describe a relative orientation of two directions may be used, but these terms encompass cases in which the two directions are not strictly in the relationship referred to by a given term. For example, when two directions are said to be parallel, this means, unless particularly indicated otherwise, not only that these two directions are exactly parallel but also that these two directions are substantially parallel. That is, the expression encompasses a case in which there are a few percentages of error, for example. Each of the optical paths illustrated in the drawings according to the following embodiments is to show a theoretical path and is not necessarily to reflect an actual optical path.

### Embodiment 1

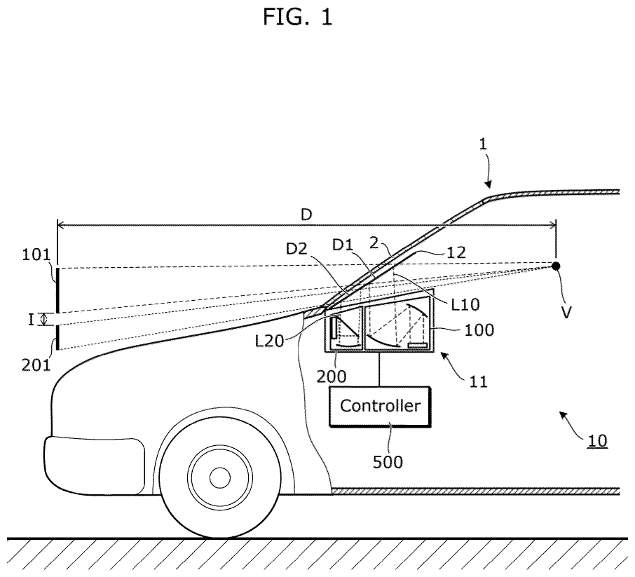

FIG. 1 is a schematic diagram showing, in a side view, a state in which display system 10 according to Embodiment 1 is provided in vehicle 1. In FIG. 1, vehicle 1 is shown in section.

As shown in FIG. 1, display system 10 includes display device 11, reflective member 12, and controller 500. Display device 11 is disposed, for example, in the dashboard of vehicle 1. Display device 11 displays, for example, vehicle information pertaining to vehicle 1 and content information in the form of first virtual image 101 and second virtual image 201. Examples of the vehicle information include, for example, the vehicle speed of vehicle 1, the rate of rotation of the engine, a detection result of an object approaching vehicle 1, navigation information from the current location of vehicle 1 to a destination, and image information showing an image captured by a camera that captures an image of the space ahead of, behind, or around vehicle 1. The content information is information with a larger amount of information than the vehicle information, and examples of the content information include, for example, video image information pertaining to entertainment.

Note that, although FIG. 1 shows an example case in which display device 11 is disposed in the dashboard, the location where display device 11 is installed is not limited by this example. For example, display device 11 may instead be disposed near the upper end of windshield 2, in the center console, or the like.

Display device 11 includes first display unit 100 that projects first image light L10 to form first virtual image 101, and second display unit 200 that projects second image light L20 to form second virtual image 201. First display unit 100 and second display unit 200 will be described later in greater detail.

Reflective member 12 is a combiner disposed between display device 11 and windshield (front glass) 2 of vehicle 1. Reflective member 12 reflects first image light L10 and second image light L20 emitted from display device 11 toward the user of display system 10, that is, toward the driver in the driver's seat, and thus reflective member 12 forms first virtual image 101 and second virtual image 201. Reflective member 12 is disposed in an inclined orientation in which its front end portion is located the lowest and its rear end portion is located the highest.

In reflective member 12, first reflective region D1 that reflects first image light L10 and second reflective region D2 that reflects second image light L20 are arranged next to each other in the up-down direction. Specifically, first reflective region D1 is located above second reflective region D2. Furthermore, the reflectance of first reflective region D1 is lower than the reflectance of second reflective region D2.

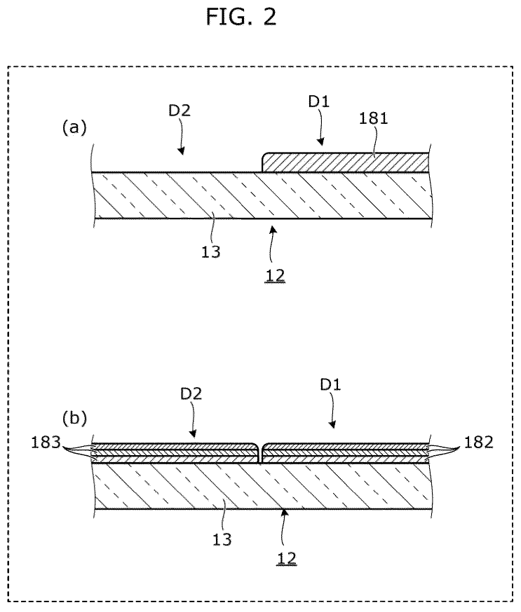

FIG. 2 is a sectional view showing, in an enlarged view, a surface structure of a part of reflective member 12 according to Embodiment 1. Herein, (a) of FIG. 2 and (b) of FIG. 2 show different embodiments.

As shown in (a) of FIG. 2, in second reflective region D2, the substrate surface of the transparent member (glass or a transparent resin) forming substrate 13 of reflective member 12 is exposed, whereas, in first reflective region D1, the substrate surface of substrate 13 is laminated with a single layer of reflective film 181. Reflective film 181 is an optical filter film that absorbs part of incident light and reflects the remaining part of the incident light. Through this configuration, the reflectance of first reflective region D1 becomes lower than the reflectance of second reflective region D2.

Meanwhile, in (b) of FIG. 2, in first reflective region D1 and second reflective region D2, the substrate surface of substrate 13 is laminated with a plurality of layers of reflective films 182 and 183, respectively. The reflectance of first reflective region D1 and the reflectance of second reflective region D2 can be adjusted by adjusting, for example, the type, the material, or the thickness of each layer of reflective films 182 and 183 or by adjusting the number of layers of reflective films 182 and 183. In this case as well, the reflectance of first reflective region D1 may, for example, be made lower than the reflectance of second reflective region D2.

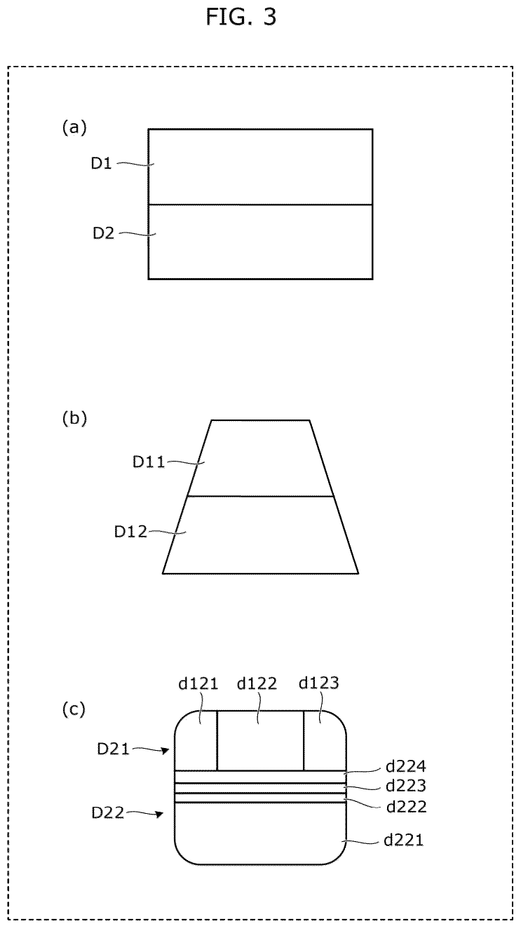

FIG. 3 is a plan view showing an example of how first reflective region D1 and second reflective region D2 are arranged according to Embodiment 1. As shown in (a) of FIG. 3, according to the present embodiment, first reflective region D1 and second reflective region D2 are both rectangular and are of substantially the same size, as viewed in plan view. Alternatively, first reflective region D1 and second reflective region D2 may be arranged, for example, in accordance with the outer shapes of first virtual image 101 and second virtual image 201. For example, as shown in (b) of FIG. 3, first reflective region D11 and second reflective region D12 may be trapezoidal as a whole, in which the upper portion of the trapezoid may serve as first reflective region D11 and the lower portion may serve as second reflective region D12.

Furthermore, the reflectance does not need to be uniform in first reflective region D21 or in second reflective region D22. As shown in (c) of FIG. 3, second reflective region D22 is divided into four sections along the up-down direction. Divided region d221 of the lowest section is the largest in size, and remaining three divided regions d222, d223, and d224 are of substantially the same size. The reflectances of divided regions d221, d222, d223, and d224 of second reflective region D22 are set to vary gradually such that the divided region located higher in second reflective region D22 has a lower reflectance. Meanwhile, first reflective region D21 is divided into three sections along the right-left direction. Divided regions d121 and d123 located at the two end portions have substantially the same reflectance, and divided region d122 located in the middle has the lowest reflectance among three divided regions d121, d122, and d123.

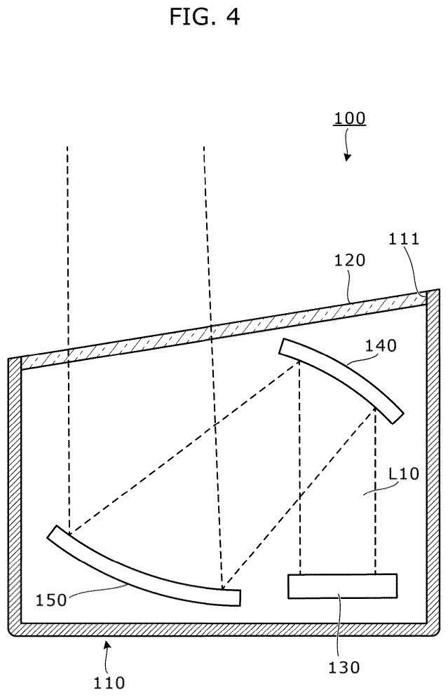

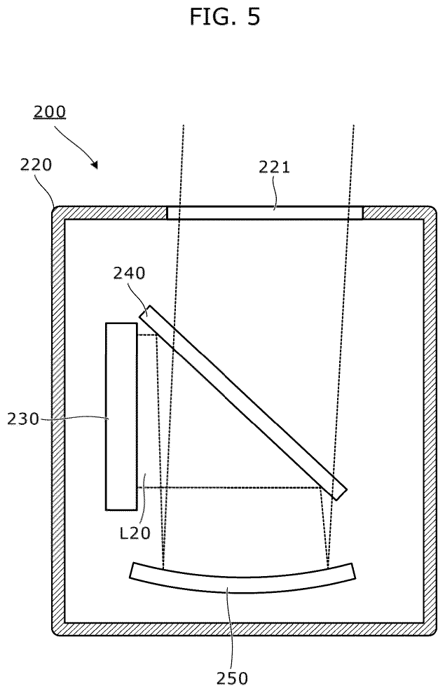

As shown in FIG. 1, controller 500 is electrically connected to first display unit 100 and second display unit 200, and controls altogether the content to be displayed by each of first display element 130 of first display unit 100 (see FIG. 4) and second display element 230 of second display unit 200 (see FIG. 5). Specifically, controller 500 includes, for example, a central processing unit (CPU), a random access memory (RAM), and a read only memory (ROM), and executes each process as the CPU loads a program stored in the ROM onto the RAM and executes the program. cl First Display Unit

First display unit 100 is an augmented reality head-up display (AR-HUD). First display unit 100 projects light toward first reflective region D1 of reflective member 12. The projected light is reflected by reflective member 12. This reflected light travels toward the eyes of the driver in the driver's seat. The driver perceives the reflected light entering his or her eyes as first virtual image 101 appearing on the other side of windshield 2 (on the outside of the vehicle) with the objects that are actually present and visible through windshield 2 in the background.

Next, a configuration of first display unit 100 will be described with reference to FIG. 4. FIG. 4 is a schematic sectional view showing first display unit 100 according to Embodiment 1. As shown in FIG. 4, first display unit 100 includes housing 110, cover portion 120, first display element 130, first optical element 140, and second optical element 150. First optical element 140 and second optical element 150 constitute an optical system for projecting image light from first display element 130 to form first virtual image 101.

Housing 110 is a box-shaped member formed of a light blocking resin or metal. Specifically, housing 110 is substantially rectangular parallelepipedal and has opening 111 formed in its upper part. Opening 111 is covered by cover portion 120. The inner space defined by housing 110 and cover portion 120 houses first display element 130, first optical element 140, and second optical element 150. Cover portion 120 is a plate member formed, for example, of a light transmissive resin or glass.

First display element 130 is, for example, a liquid crystal panel, and when illuminated with light from a backlight (a light source) (not shown), projects first image light L10 that forms first virtual image 101 toward first optical element 140. First display element 130 may instead be an organic electroluminescent (EL) panel. First display element 130 is formed in a rectangular shape, as viewed in plan view, and is disposed in an orientation in which first display element 130 is parallel to the horizontal plane.

First optical element 140 is an optical element that is disposed in the optical path of first image light L10 emitted from first display element 130 and that reflects first image light L10 toward second optical element 150. First optical element 140 is a concave mirror formed in a rectangular shape, as viewed in plan view. First optical element 140 is disposed in an orientation in which first optical element 140 is inclined relative to the vertical plane. The reflective surface of first optical element 140 faces first display element 130 and second optical element 150. In other words, first optical element 140 is disposed such that its reflective surface constituted by the mirror surface of its concave mirror faces inward of housing 110 and its convex surface faces outward of housing 110.

Second optical element 150 is an optical element that is disposed in the optical path of first image light L10 reflected by first optical element 140 and that reflects first image light L10 reflected by first optical element 140 toward opening 111. Specifically, second optical element 150 is a concave mirror formed in a rectangular shape, as viewed in plan view. Second optical element 150 is disposed in an orientation in which second optical element 150 faces the reflective surface of first optical element 140 and is inclined relative to the vertical plane of housing 110. The reflective surface of second optical element 150 faces first optical element 140 and cover portion 120. In other words, second optical element 150 is disposed such that its reflective surface constituted by the mirror surface of its concave mirror faces inward of housing 110 and its convex surface faces outward of housing 110. First image light L10 reflected by second optical element 150 is projected toward reflective member 12 via opening 111. First image light L10 is reflected by first reflective region D1 of reflective member 12. Upon being reflected, first image light L10 travels toward the eyes of the driver in the driver's seat and produces first virtual image 101. In this manner, first optical element 140 and second optical element 150, combined, serve as one example of a first set of optical members forming the optical path of first image light L10.

FIG. 1 shows the position where, from the driver's viewpoint, he or she perceives first virtual image 101 to appear. This position can be set by adjusting the apparent distance of first image light L10 projected from first display element 130 of first display unit 100. The driver's viewpoint is, for example, a reference eye point. A reference eye point is “a point representative of the position of the driver's eyes in a normal driving state”.

### Second Display Unit

As shown in FIG. 1, second display unit 200 projects light toward second reflective region D2 of reflective member 12. The projected light is reflected by reflective member 12. This reflected light travels toward the eyes of the driver in the driver's seat. The driver perceives the reflected light entering his or her eyes as second virtual image 201 appearing on the other side of windshield 2 (on the outside of the vehicle) with the objects that are actually present and visible through windshield 2 in the background.

Next, a configuration of second display unit 200 will be described with reference to FIG. 5. FIG. 5 is a schematic sectional view showing second display unit 200 according to Embodiment 1. As shown in FIG. 5, second display unit 200 includes housing 220, second display element 230, polarizing half-silvered mirror 240, and reflective mirror 250. Polarizing half-silvered mirror 240 and reflective mirror 250 constitute an optical system for projecting second image light L20 from second display element 230 to form second virtual image 201.

Housing 220 is a box-shaped member formed of a light blocking resin or metal. Opening 221 is formed in the upper part of housing 220. Image light to form second virtual image 201 is projected through opening 221. The inner space of housing 220 houses second display element 230, polarizing half-silvered mirror 240, and reflective mirror 250.

Second display element 230 is, for example, a liquid crystal panel, and when illuminated with light from a light source (not shown), projects second image light L20 that forms second virtual image 201 toward polarizing half-silvered mirror 240. Second display element 230 may instead be an organic EL panel. Second display element 230 is disposed in an orientation in which the display surface of second display element 230 faces rearward of vehicle 1. Although the illustration is omitted, the display surface of second display element 230 is laminated with a quarter-wave retardation plate (abbreviated below as a quarter-wave plate). The quarter-wave plate is a quarter-wave retardation plate that causes a phase difference of a quarter of wavelength \ to the light incident on the quarter-wave plate. For example, when light emitted from the display surface is linearly polarized light of S polarization, this light, by passing through the quarter-wave plate, is converted to circularly polarized light.

Polarizing half-silvered mirror 240 is configured to reflect P-polarized light and to transmit S-polarized light, and is constituted by a planar glass substrate provided with a reflective polarizing plate. Furthermore, the surface of polarizing half-silvered mirror 240 is laminated with a quarter-wave plate. Polarizing half-silvered mirror 240 is disposed in an orientation in which polarizing half-silvered mirror 240 faces second display element 230 and reflective mirror 250. Second image light L20 of S polarization emitted from second display element 230 is converted to circularly polarized light by the quarter-wave plate on second display element 230, and the resulting circularly polarized light travels toward polarizing half-silvered mirror 240. This second image light L20 of circular polarization is converted to P-polarized light by the quarter-wave plate on polarizing half-silvered mirror 240, and the resulting P-polarized light is reflected by a reflective polarizing plate of polarizing half-silvered mirror 240. This reflected second image light L20 of P polarization, by being transmitted through the quarter-wave plate again, is converted to circularly polarized light. In this manner, polarizing half-silvered mirror 240 is disposed in an orientation in which, with the quarter-wave plate and the reflective polarizing plate on polarizing half-silvered mirror 240, second image light L20 incident on polarizing half-silvered mirror 240 as circularly polarized light is reflected toward reflective mirror 250 as circularly polarized light.

Reflective mirror 250 is a concave mirror and is disposed below polarizing half-silvered mirror 240, in the paper plane of FIG. 5. Reflective mirror 250 is disposed in an orientation in which its concave surface constituting the reflective surface faces upward. Second image light L20 of circular polarization reflected by polarizing half-silvered mirror 240 is reflected by reflective mirror 250 as circularly polarized light with no change, and travels back toward polarizing half-silvered mirror 240. Second image light L20 incident on polarizing half-silvered mirror 240 is converted to S-polarized light by the quarter-wave plate on polarizing half-silvered mirror 240, transmitted through the reflective polarizing plate of polarizing half-silvered mirror 240 to travel upward in the paper plane of FIG. 5, and projected toward reflective member 12 via opening 221. Second image light L20 is reflected by second reflective region D2 of reflective member 12. Upon being reflected, second image light L20 travels toward the eyes of the driver in the driver's seat and produces second virtual image 201. In this manner, polarizing half-silvered mirror 240 and reflective mirror 250, combined, constitute one example of a second set of optical members forming the optical path of second image light L20.

FIG. 1 shows the position where, from the driver's viewpoint, he or she perceives second virtual image 201 to appear. This position can be set by adjusting the apparent distance of second image light L20 projected from second display element 230 of second display unit 200.

### Positional Relationship Between First Virtual Image And Second Virtual Image

Next, a positional relationship between first virtual image 101 and second virtual image 201 will be described. As shown in FIG. 1, first virtual image 101 and second virtual image 201 are both positioned ahead of the driver and ahead of reflective member 12. Specifically, first virtual image 101 and second virtual image 201 are positioned at distance D ahead of viewpoint V of the driver. Distance D is greater than or equal to 1.5 meters and less than or equal to 3.0 meters.

When vehicle 1 is viewed from the side, first virtual image 101 is formed in an orientation in which first virtual image 101 is parallel to the vertical plane of vehicle 1. When vehicle 1 is viewed from the side, second virtual image 201 is positioned below first virtual image 101. Second virtual image 201 is formed in an orientation in which second virtual image 201 is parallel to the vertical plane of vehicle 1. First virtual image 101 and second virtual image 201 are positioned such that the lower end of first virtual image 101 and the upper end of second virtual image 201 are spaced apart by interval I of no more than 2 diopters, as viewed in side view. Interval I is the length of a straight line connecting the lower end of first virtual image 101 and the upper end of second virtual image 201. Herein, a diopter is defined as the difference between the reciprocal of the distance from viewpoint V to the upper end of second virtual image 201 and the reciprocal of the distance from viewpoint V to the lower end of first virtual image 101.

### Display Example of First Virtual Image And Second Virtual Image

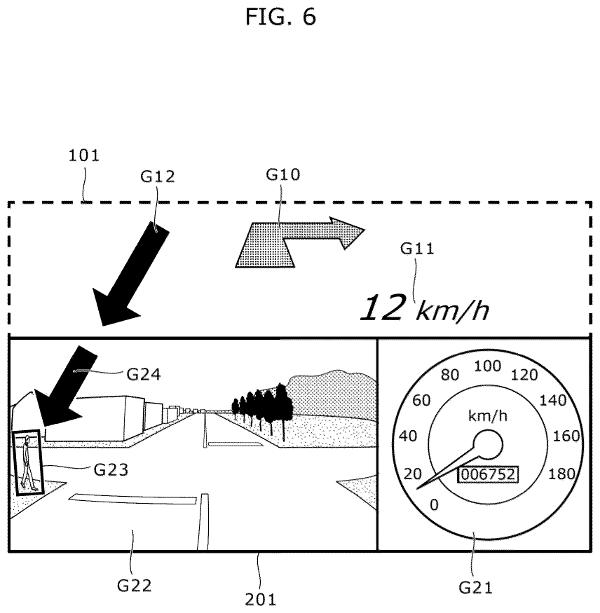

Next, an example of how first virtual image 101 and second virtual image 201 are displayed will be described. FIG. 6 is an explanatory drawing showing an example of how first virtual image 101 and second virtual image 201 are displayed according to Embodiment 1. FIG. 6 shows first virtual image 101 and second virtual image 201 as they are viewed from the driver.

As shown in FIG. 6, in first virtual image 101, navigation information G10 and so forth for vehicle 1 are displayed. Specifically, in first virtual image 101, an arrow instructing the driver to turn right, as navigation information G10, as well as vehicle speed meter G11 and arrow G12 is displayed. Arrow G12 is a mark for guiding the gaze of the driver toward an object to be aware of in second virtual image 201.

In second virtual image 201, vehicle speed meter G21 serving as vehicle information and surrounding image G22 of the space ahead of vehicle 1 captured by a camera are displayed. When controller 500 detects at least one of a pedestrian, an animal, a two-wheeled vehicle, or a traveling vehicle other than vehicle 1 by subjecting surrounding image G22 to predetermined image processing, controller 500 marks the detected at least one as an object to be aware of. For example, by controlling display device 11, controller 500 displays frame image G23 enclosing an object to be aware of superposed on surrounding image G22. At this point, controller 500 displays arrow G24 between arrow G12 and frame image G23. Arrows G12 and G24 make it possible to guide the gaze of the driver to frame image G23 and to the object to be aware of.

In this case, the set of images displayed in first virtual image 101 is one example of first information, and the set of images displayed in second virtual image 201 is one example of second information having a larger amount of information than the first information. Since the first information with a smaller amount of information is displayed in first virtual image 101 formed by the light reflected by first reflective region D1 of a lower reflectance, the first information is less noticeable and is less likely to hinder the forward visibility of the driver of vehicle 1. In contrast, the second information with a larger amount of information is displayed in second virtual image 201 formed by the light reflected by second reflective region D2 of a higher reflectance, and thus the second information can present a clearer image.

### Advantageous Effects and Others

As described thus far, according to the present embodiment, since first virtual image 101 and second virtual image 201 are both positioned ahead of the driver and ahead of reflective member 12, the driver's effort to adjust the focus when his or her gaze moves between first virtual image 101 and second virtual image 201 can be reduced. Accordingly, the stress that the driver experiences when looking at and recognizing first virtual image 101 and second virtual image 201 can be reduced.

Furthermore, since first virtual image 101 and second virtual image 201 can be positioned at their respective predetermined positions with the use of single reflective member 12, the entire system can be reduced in size. Since first reflective region D1 and second reflective region D2 of reflective member 12 have different reflectances, first reflective region D1 can be assigned a reflectance suitable for first virtual image 101, and second reflective region D2 can be assigned a reflectance suitable for second virtual image 201. Accordingly, first virtual image 101 and second virtual image 201 can each be displayed in a well-fitted manner.

In addition, since first reflective region D1 is positioned above second reflective region D2, first virtual image 101 and second virtual image 201 can be positioned next to each other in the up-down direction. In other words, first virtual image 101 and second virtual image 201, when viewed as a whole, form a virtual image divided in the horizontal direction, and such a virtual image can be visually recognized easily by the driver.

Furthermore, since the reflectance of first reflective region D1 located above second reflective region D2 is lower than the reflectance of second reflective region D2, first virtual image 101 can be made less noticeable than second virtual image 201. Accordingly, first virtual image 101 that more easily enters the driver's view when he or she looks ahead is less likely to hinder the forward visibility of the driver.

Herein, it is desirable to set the reflectance of second reflective region D2 10% or more higher than the reflectance of first reflective region D1. With this configuration, second virtual image 201 formed by the light reflected by second reflective region D2 may be more visible. This percentage may be more preferably 30% or more. When this percentage is less than 10%, the difference between first virtual image 101 and second virtual image 201 becomes not very noticeable to the driver. Furthermore, since first display element 130 that forms first image light L10 and second display element 230 that forms second image light L20 are provided, this configuration makes it possible to control first display element 130 and second display element 230 independently of each other. Accordingly, first virtual image 101 formed by first image light L10 and second virtual image 201 formed by second image light L20 can be controlled independently of each other easily.

Furthermore, since reflective member 12 is a transparent member, reflective member 12 can be kept from interfering with the driver's view ahead.

Furthermore, since first virtual image 101 and second virtual image 201 are positioned with interval I of no more than 2 diopters therebetween, as viewed in side view, the driver's effort to adjust the focus when his or her gaze moves between first virtual image 101 and second virtual image 201 can be further reduced. Accordingly, the stress that the driver experiences when looking at and recognizing first virtual image 101 and second virtual image 201 can be further reduced. This point is advantageous for a driver with a reduced focus adjusting ability (e.g., an elderly driver). Herein, it is more preferable that interval I be within 1 diopter.

Furthermore, adjusting the layer structure (the number of layers, the materials, etc.) of reflective film 181, 182, or 183 on at least one of first reflective region D1 or second reflective region D2 makes it possible to increase the design flexibility of the reflectance or the reflection spectrum of at least one of first reflective region D1 or second reflective region D2.

Furthermore, second reflective region D2 having a higher reflectance than first reflective region D1 reflects second image light L20 to project second virtual image 201. Although second virtual image 201 presents the second information with a larger amount of information than the first information, since second virtual image 201 is formed by the light reflected by second reflective region D2, the second information can be displayed clearly.

### Embodiment 2

Embodiment 2 will now be described. It is to be noted that, in the following description, components identical to those according to the other embodiments are given identical reference characters, and description thereof may be omitted.

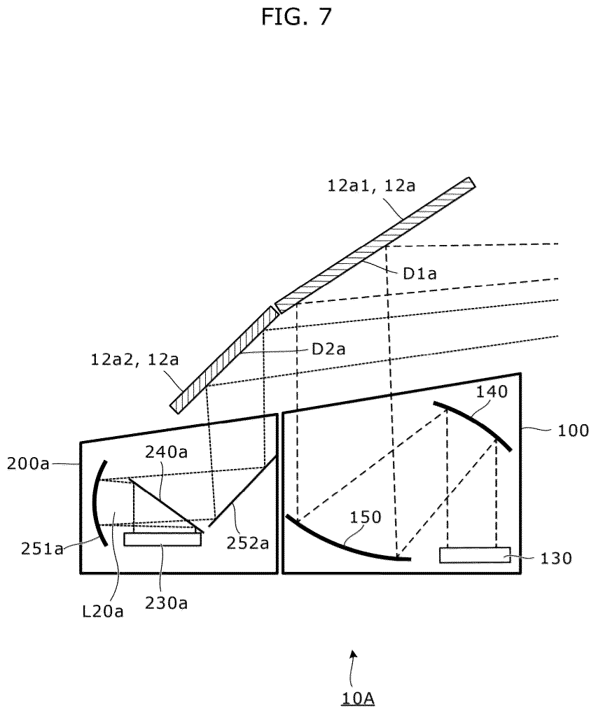

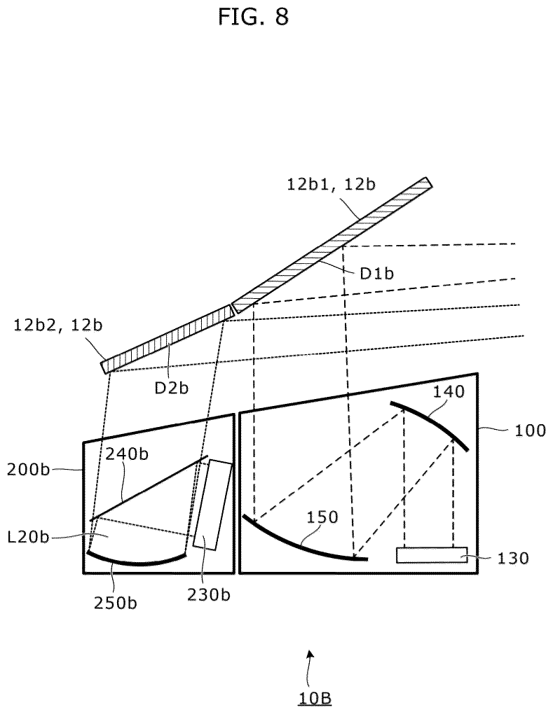

In the case illustrated according to Embodiment 1 above, reflective member 12 is constituted by a single member. In the case described according to Embodiment 2, reflective members 12a and 12b are each constituted by two members. FIG. 7 and FIG. 8 are schematic diagrams showing display systems 10A and 10B, respectively, according to Embodiment 2.

As shown in FIG. 7, reflective member 12a of display system 10A includes first reflective member 12a1 and second reflective member 12a2. First reflective member 12a1 is disposed above second reflective member 12a2. Second reflective member 12a2 is disposed in an orientation in which second reflective member 12a2 is inclined at a greater angle than first reflective member 12a1 relative to the horizontal plane. First reflective member 12a1 includes first reflective region D1a. Second reflective member 12a2 includes second reflective region D2a. In other words, first reflective region Da and second reflective region D2a are inclined in different orientations, as viewed in side view.

Since the inclination of second reflective region D2a relative to the horizontal plane is greater than the inclination of first reflective region D1a relative to the horizontal plane, the configuration and the layout of a second set of optical elements within second display unit 200a can be made to differ from the configuration and the layout of the second set of optical elements according to Embodiment 1. Specifically, in second display unit 200a, second display element 230a, first reflective mirror 251a, polarizing half-silvered mirror 240a, and second reflective mirror 252a are disposed. First reflective mirror 251a, polarizing half-silvered mirror 240a, and second reflective mirror 252a forming the second set of optical elements are configured to form the optical path of second image light L20a that extends from second display element 230a and to guide second image light L20a to second reflective region D2a. This configuration can add the path of the light reflected by second reflective mirror 252a; thus, a greater optical path length can be obtained, and second virtual image 201 can be displayed further away from the vehicle.

As shown in FIG. 8, reflective member 12b of display system 10B includes first reflective member 12b1 and second reflective member 12b2. First reflective member 12b1 is disposed above second reflective member 12b2. Second reflective member 12b2 is disposed in an orientation in which second reflective member 12b2 is inclined at a smaller angle than first reflective member 12b1 relative to the horizontal plane. First reflective member 12b1 includes first reflective region D1b. Second reflective member 12b2 includes second reflective region D2b. In other words, first reflective region D1b and second reflective region D2b are inclined in different orientations, as viewed in side view.

Since the inclination of second reflective region D2b relative to the horizontal plane is smaller than the inclination of first reflective region D1b relative to the horizontal plane, the configuration and the layout of a second set of optical elements within second display unit 200b can be made to differ from the configuration and the layout of the second set of optical elements according to Embodiment 1. Specifically, in second display unit 200b, second display element 230b, polarizing half-silvered mirror 240b, and reflective mirror 250b are disposed. Polarizing half-silvered mirror 240b and reflective mirror 250b forming the second set of optical elements are configured to form the optical path of second image light L20b that extends from second display element 230b and to guide second image light L20b to second reflective region D2b. This configuration can reduce the size of second display unit 200b, as compared to the size of second display unit 200a shown in FIG. 7.

In this manner, since first reflective regions D1a and D1b are inclined at different angles than their corresponding second reflective regions D2a and D2b, as viewed in side view, the flexibility of the layout of the second set of optical members forming the optical path of second image light L20a or second image light L20b can be increased. Note that this can also be said with regard to the first set of optical members.

### Embodiment 3

Embodiment 3 will now be described. In the case illustrated according to Embodiment 1 above, two arrows G12 and G24 are displayed to guide the gaze of the driver. In the case described according to Embodiment 3, a single mark is displayed continuously over a first virtual image and a second virtual image.

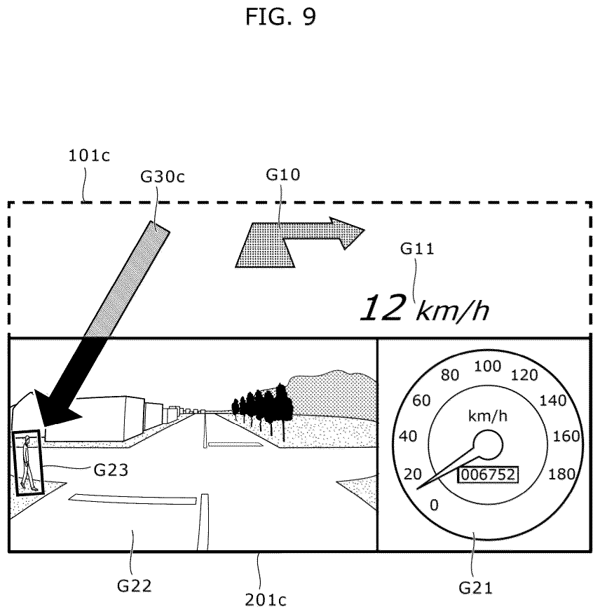

FIG. 9 is an explanatory drawing showing an example of how first virtual image 101c and second virtual image 201c are displayed according to Embodiment 3. As shown in FIG. 9, arrow G30c is one example of a mark displayed continuously over first virtual image 101c and second virtual image 201c. Arrow G30c is formed continuously so as to appear over first virtual image 101c and second virtual image 201c. In this manner, since arrow G30c is formed continuously over first virtual image 101c and second virtual image 201c, this configuration makes it possible to guide the gaze of the driver smoothly between first virtual image 101c and second virtual image 201c based on arrow G30c.

### Embodiment 4

Embodiment 4 will now be described. According to Embodiment 1 above, reflective member 12 is illustrated in which the reflectance of first reflective region D1 and the reflectance of second reflective region D2 are fixed. Alternatively, the reflectance of at least one of the first reflective region or the second reflective region may be variable. In the case described according to Embodiment 4, the reflectance of the first reflective region is variable, and the reflectance of the second reflective region is fixed. Alternatively, the reflectance of the first reflective region may be fixed, and the reflectance of the second reflective region may be variable; or the reflectances of both the first reflective region and the second reflective region may be variable.

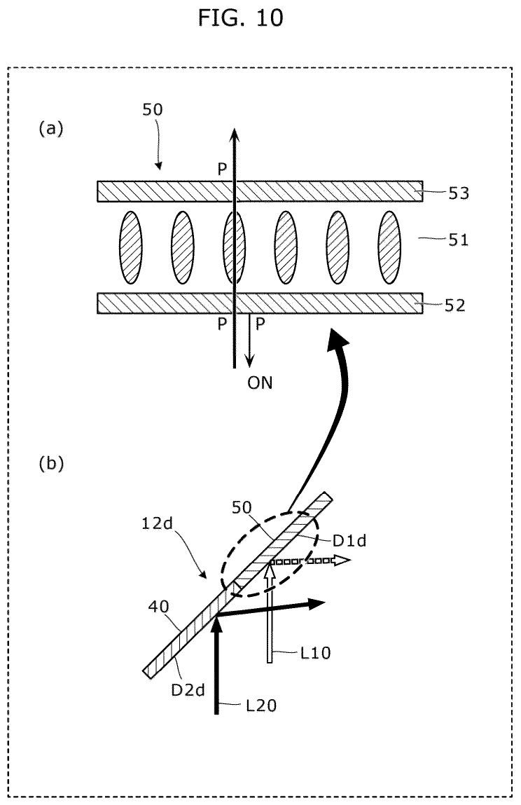

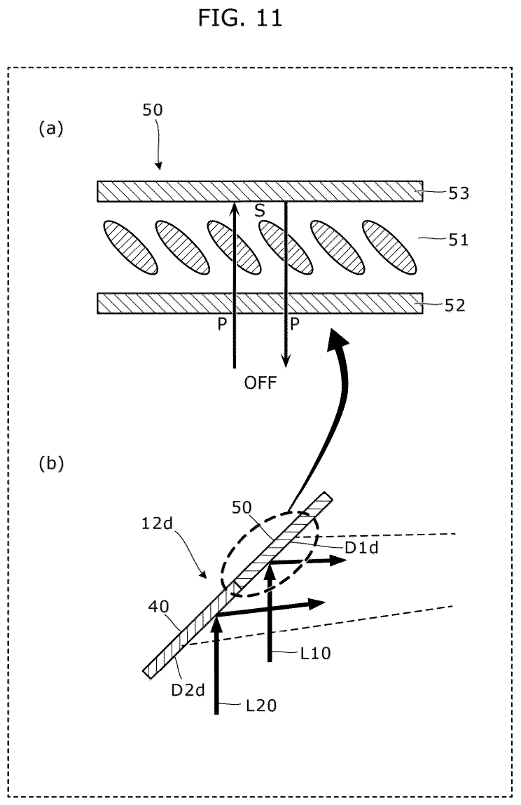

FIG. 10 and FIG. 11 are each an explanatory drawing showing reflective member 12d according to Embodiment 4. FIG. 10 shows a state held before the reflectance of first reflective region Did is adjusted, and FIG. 11 shows a state held after the reflectance of first reflective region D1d is adjusted. Herein, (a) of FIG. 10 and (a) of FIG. 11 are enlarged views of first reflective region D1d, and (b) of FIG. 10 and (b) of FIG. 11 are schematic sectional views of reflective member 12d.

As shown in (b) of FIG. 10 and (b) of FIG. 11, the portion of reflective member 12d that serves as second reflective region D2d is formed by optical member 40 having a fixed reflectance, and the portion of reflective member 12d that serves as first reflective region D1d is formed by liquid crystal mirror 50 having a variable reflectance. Optical member 40 and liquid crystal mirror 50 are formed as a single integrated piece.

Optical member 40 is, for example, a transparent member formed, for example, of glass or a transparent resin. Liquid crystal mirror 50 can be switched between a first state in which liquid crystal mirror 50 reflects first image light L10 and a second state in which liquid crystal mirror 50 transmits most of first image light L10, based on the control performed by controller 500.

Herein, (a) of FIG. 10 shows liquid crystal mirror 50 in the second state, and (a) of FIG. 11 shows liquid crystal mirror 50 in the first state. Liquid crystal mirror 50 includes liquid crystal layer 51 as well as first polarizing plate 52 and second polarizing plate 53 that sandwich liquid crystal layer 51. First polarizing plate 52 is disposed to the side of liquid crystal layer 51 that is closer to display device 11, and second polarizing plate 53 is disposed to the side of liquid crystal layer 51 that is opposite to where first polarizing plate 52 is disposed. For example, first polarizing plate 52 is a transmissive polarizing plate that transmits linearly polarized light of P polarization (also referred to below as P-polarized light) and absorbs light of the other polarizations. Alternatively, first polarizing plate 52 may be a reflective polarizing plate that transmits P-polarized light and reflects light of the other polarizations. Second polarizing plate 53 is a reflective polarizing plate that transmits P-polarized light and reflects linearly polarized light of S polarization (also referred to below as S-polarized light). Herein, the side of second polarizing plate 53 that is opposite to where liquid crystal layer 51 is disposed may be laminated with a transmissive polarizing plate that transmits P-polarized light and absorbs S-polarized light.

As shown in (a) of FIG. 10, in the second state, a voltage is being applied to liquid crystal layer 51, and the many liquid crystal molecules in liquid crystal layer 51 are arrayed in an orientation in which the liquid crystal molecules transmit P-polarized light as P-polarized light with no change. Therefore, most of first image light L10 of P polarization is transmitted through first polarizing plate 52 and liquid crystal layer 5, is then transmitted through second polarizing plate 53, and exits liquid crystal mirror 50. At this point, part of first image light L10 is reflected by the surface of first polarizing plate 52 and travels toward the driver. Meanwhile, as shown in (b) of FIG. 10, second image light L20 is reflected by second reflective region D2d without being attenuated that much by second reflective region D2d. Through this mechanism, in the second state, the reflectance of first reflective region Did becomes lower than the reflectance of second reflective region D2d.

In contrast, as shown in (a) of FIG. 11, in the first state, no voltage is being applied to liquid crystal layer 51, and the many liquid crystal molecules in liquid crystal layer 51 are arrayed in an orientation in which the liquid crystal molecules can convert P-polarized light to S-polarized light. Therefore, first image light L10 of P polarization is transmitted through first polarizing plate 52 and is then transmitted through liquid crystal layer 51, and is thus converted to S-polarized light. This first image light L10 of S polarization is reflected by second polarizing plate 53. Reflected first image light L10 of S polarization is transmitted through liquid crystal layer 51 again and is thus converted to P-polarized light. Through this configuration, first image light L10 of P polarization is transmitted through first polarizing plate 52 and exits liquid crystal mirror 50 toward the driver. In other words, first image light L10 in the first state is less attenuated than first image light L10 in the second state. In particular, according to the present embodiment, the reflectance of first reflective region D1d in the first state is made to coincide with the reflectance of second reflective region D2d. As described above, the first state and the second state are switched therebetween based on the control performed by controller 500. In other words, it can be said that controller 500 is equipped with an equalizing mode that causes the reflectance of first reflective region Did and the reflectance of second reflective region D2d to coincide with each other.

Since, upon the equalizing mode being executed, the reflectance of first reflective region D1d and the reflectance of second reflective region D2d are made to coincide with each other, the display state of first virtual image 101 and the display state of second virtual image 201 can be made to coincide with each other. With this configuration, when, for example, the driver does not need to pay close attention to what lies ahead of vehicle 1 (during self-driving or when parking), a shared image can be displayed broadly by first virtual image 101 and second virtual image 201. If, for example, content information, such as a movie, can be displayed by first virtual image 101 and second virtual image 201, the driver can view that content information on a large screen.

In this manner, since the reflectance of first reflective region D1d is variable, the reflectance of first reflective region D1d can be adjusted, for example, in accordance with the circumstances surrounding the vehicle. Accordingly, first virtual image 101 can be displayed in a well-fitted manner in accordance with the surrounding circumstances.

Herein, when the reflectance of second reflective region D2d is variable, second virtual image 201 can be displayed in a well-fitted manner in accordance with the surrounding circumstances. Furthermore, if the reflectance of second reflective region D2d is made to coincide with the reflectance of first reflective region D1d, the area of transmissive display can be increased.

### Embodiment 5

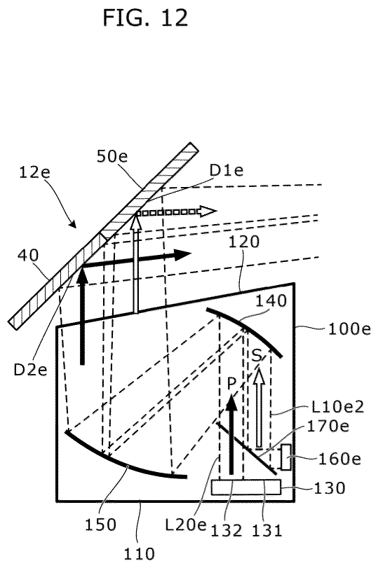

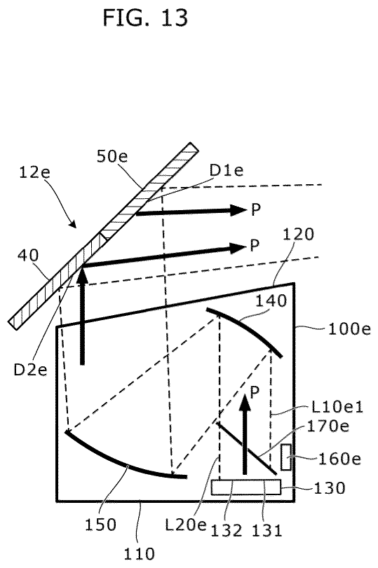

Embodiment 5 will now be described. In the case illustrated according to Embodiment 1 above, first display unit 100 projects first image light L10, and second display unit 200 projects second image light L20. In the case described according to Embodiment 5, first display unit 100e projects both first image light L10 and second image light L20. Therefore, no second display unit is provided according to Embodiment 5. FIG. 12 and FIG. 13 are each an explanatory drawing showing first display unit 100e and reflective member 12e according to Embodiment 5.

As shown in FIG. 12 and FIG. 13, the portion of reflective member 12e that serves as second reflective region D2e is formed by optical member 40 having a fixed reflectance, and the portion of reflective member 12e that serves as first reflective region D1e is formed by liquid crystal mirror 50e having a variable reflectance. Optical member 40 and liquid crystal mirror 50e are formed as a single integrated piece.

Liquid crystal mirror 50e can be switched between a second state in which liquid crystal mirror 50e transmits P-polarized light and absorbs S-polarized light and a first state in which liquid crystal mirror 50e reflects P-polarized light and absorbs S-polarized light. Liquid crystal mirror 50e can be switched between the first state and the second state by the control performed by controller 500.

First display unit 100e includes housing 110, cover portion 120, first display element 130, first optical element 140, second optical element 150, display element 160e, and polarizing half-silvered mirror 170e. Herein, the area onto which first display unit 100e can project light is the total area of first reflective region D1e and second reflective region D2e combined. Furthermore, the area where first display element 130 can provide display is also the area corresponding to the stated total area. Therefore, first display element 130 includes first display area 131 that corresponds to first reflective region D1e and second display area 132 that corresponds to second reflective region D2e. As shown in FIG. 13, first display area 131 emits first image light L10e1 of P polarization, and second display area 132 emits second image light L20e of P polarization.

Display element 160e is disposed above first display element 130 and to the rearward of vehicle 1 and disposed in an orientation in which its display surface faces forward. Display element 160e is, for example, a liquid crystal panel, and when illuminated with light from a backlight (a light source) (not shown), emits first image light L10e2 of S polarization, as shown in FIG. 12. The content displayed by display element 160e is controlled by controller 500.

Polarizing half-silvered mirror 170e is an optical member that transmits P-polarized light and reflects S-polarized light. Polarizing half-silvered mirror 170e is disposed between first display element 130 and first optical element 140 and to the front of display element 160e. Polarizing half-silvered mirror 170e is disposed in an inclination in which the rear end portion is positioned the lowest and the front end portion is positioned the highest.

When liquid crystal mirror 50e is set in the second state as shown in FIG. 12, controller 500 turns off first display area 131 of first display element 130 and causes second image light L20e of P polarization to be emitted from second display area 132. Furthermore, controller 500 causes first image light L10e2 of S polarization to be emitted from display element 160e.

At this point, second image light L20e of P polarization is transmitted through polarizing half-silvered mirror 170e, is reflected by first optical element 140 and second optical element 150, is reflected then by second reflective region De, and travels toward the driver.

Meanwhile, first image light L10e2 of S polarization is reflected by polarizing half-silvered mirror 170e, is reflected by first optical element 140 and second optical element 150, and then travels toward first reflective region D1e. At this point, since liquid crystal mirror 50e is in the second state, most of first image light L10e2 of S polarization is absorbed, but part of first image light L10e2 of S polarization is reflected by the surface of liquid crystal mirror 50e and travels toward the driver. This configuration makes it possible for the driver to see first virtual image 101 formed by first image light L10e2.

When liquid crystal mirror 50 is set in the first state as shown in FIG. 13, that is, when the equalizing mode is being executed, controller 500 turns off display element 160e. Furthermore, controller 500 causes first image light L10e1 of P polarization to be emitted from first display area 131 of first display element 130 and causes second image light L20e of P polarization to be emitted from second display area 132.

First image light L10e1 and second image light L20e both of P polarization are transmitted through polarizing half-silvered mirror 170e, are reflected by first optical element 140 and second optical element 150, are reflected then by first reflective region D1e and second reflective region D2e, and travel toward the driver.

In this manner, when the equalizing mode is being executed, image light (first image light L10e1 and second image light L20e) from the two display elements alone (first display element 130 and display element 160e) is projected toward first reflective region D1e and second reflective region D2e, and thus the image quality of first virtual image 101 and the image quality of second virtual image 201 can be made to coincide with each other.

### Embodiment 6

Embodiment 6 will now be described. In the case illustrated according to Embodiment 4 above, the reflectance of only first reflective region D1d of reflective member 12d is variable. In the case described according to Embodiment 6, the reflectance of the entire reflective member is variable.

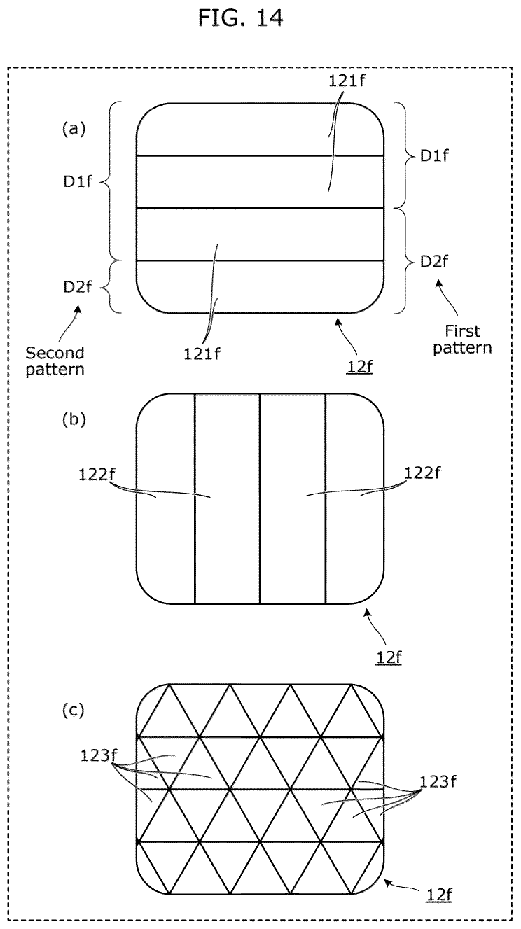

FIG. 14 is a plan view showing reflective member 12f according to Embodiment 6. In FIG. 14, (a), (b), and (c) show different embodiments of reflective member 12f. Reflective member 12f shown in (a) of FIG. 14 includes four unit regions 121f divided in the up-down direction. Each of unit regions 121f has a rectangular shape longer in the right-left direction, and unit regions 121f are of substantially the same size. In this manner, in reflective member 12f shown in (a) of FIG. 14, a plurality of unit regions 121f are arrayed in a regular pattern. Each of unit regions 121f is constituted by an independent liquid crystal mirror. This configuration makes it possible to adjust the reflectance of each of unit regions 121f independently of each other. Controller 500, by controlling each liquid crystal mirror, can adjust the size and the position of first reflective region D1f and second reflective region D2f of reflective member 12f. Herein, (a) of FIG. 14 shows, as examples, a first pattern in which the upper two of unit regions 121f constitute first reflective region D1f and the lower two of unit regions 121f constitute second reflective region D2f, and a second pattern in which the upper three of unit regions 121f constitute first reflective region D1f and the lower one of unit regions 121f constitutes second reflective region D2f.

Reflective member 12f shown in (b) of FIG. 14 includes four unit regions 122f divided in the right-left direction. Each of unit regions 122f has a rectangular shape longer in the up-down direction, and unit regions 122f are of substantially the same size. In this manner, in reflective member 12f shown in (b) of FIG. 14, a plurality of unit regions 122f are arrayed in a regular pattern. Each of unit regions 122f is constituted by an independent liquid crystal mirror. This configuration makes it possible to adjust the reflectance of each of unit regions 122f independently of each other.

Reflective member 12f shown in (c) of FIG. 14 includes unit regions 123f each having the shape of a right triangle, and unit regions 123f are arrayed densely in a two-dimensional plane. Herein, unit regions 123f located on the outer peripheral portion of reflective member 12f have a shape cut out from a right triangle. With regard to this reflective member 12f shown in (c) of FIG. 14, a plurality of unit regions 123f are said to be arrayed in a regular pattern. Each of unit regions 123f is constituted by an independent liquid crystal mirror. This configuration makes it possible to adjust the reflectance of each of unit regions 123f independently of each other. Herein, as long as a plurality of unit regions are arrayed in a regular pattern, the unit regions may have any shapes other than the ones described above, and there is no limitation on the number of unit regions to be provided.

In this manner, since the reflectance of each of unit regions 121f, 122f, or 123f of reflective member 12f is variable, the size and the position of the first reflective region and the second reflective region can be adjusted by varying the reflectance of each of unit regions 121f, 122f, or 123f. Accordingly, the size of first virtual image 101 and second virtual image 201 can be adjusted.

### Embodiment 7

Embodiment 7 will now be described. In the case illustrated according to Embodiment 1 above, first image light L10 is formed by first display element 130, and second image light L20 is formed by second display element 230. In the case described according to Embodiment 7, a single display element forms both first image light and second image light.

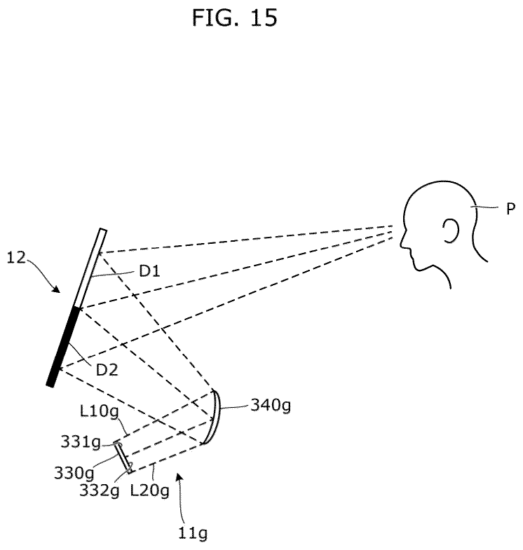

FIG. 15 is an explanatory drawing showing display device 11g according to Embodiment 7. As shown in FIG. 15, display device 11g includes display element 330g and reflective mirror 340g. Display element 330g includes first display area 331g that corresponds to first reflective region D1, and second display area 332g that corresponds to second reflective region D2. Display element 330g is, for example, a liquid crystal panel, and when illuminated with light from a backlight (a light source) (not shown), emits first image light L10g from first display area 331g and second image light L20g from second display area 332g.

Reflective mirror 340g is a concave mirror having a free-form surface and is configured to reflect first image light L10g emitted from display element 330g toward first reflective region D1 and to reflect second image light L20g emitted from display element 330g toward second reflective region D2. First image light L10g, upon being reflected by first reflective region D1, travels toward the driver to form first virtual image 101, and second image light L20g, upon being reflected by second reflective region D2, travels toward the driver to form second virtual image 201.

In this manner, since both the first image light and the second image light are formed by single display element 330g, this configuration can reduce the size of display device 11g, as compared to the case in which a dedicated display element is provided for each image light.

### Embodiment 8

Embodiment 8 will now be described. In the case illustrated according to Embodiment 7, first reflective region D1 and second reflective region D2 are fixed. In the case described according to Embodiment 8, the size and the position of the first reflective region and the second reflective region are adjusted based on the position of the driver's viewpoint.

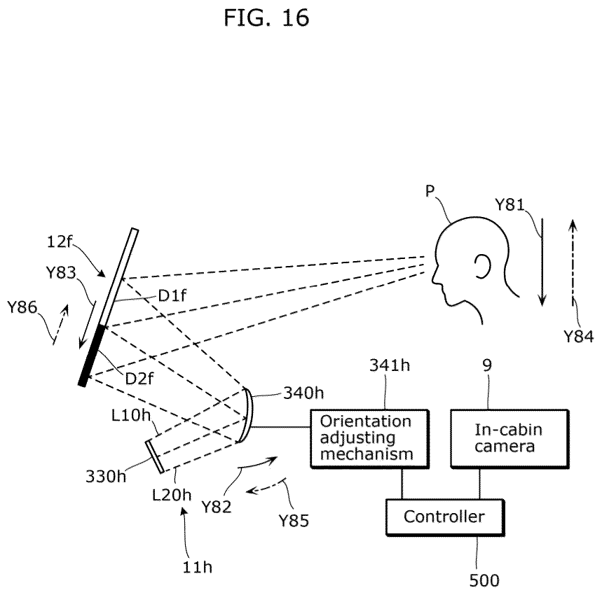

FIG. 16 is an explanatory drawing showing display device 11h and reflective member 12f according to Embodiment 8. Herein, as described according to Embodiment 6, in reflective member 12f, the size and the position of first reflective region D1f and second reflective region D2f can be adjusted.

Display device 11h includes display element 330h and reflective mirror 340h. Display element 330h and reflective mirror 340h are each one example of an optical element for forming first image light L10h and second image light L20h. Display element 330h is disposed to the front of reflective mirror 340h.

Reflective mirror 340h is installed such that its orientation can be adjusted freely. Specifically, reflective mirror 340h is held such that it can swing freely with its upper end portion being the center of rotation. Display device 11h is provided with orientation adjusting mechanism 341h for adjusting the orientation of reflective mirror 340h.

Controller 5 controls in-cabin camera 9 provided in vehicle 1 and orientation adjusting mechanism 341h. Specifically, controller 500 detects the position of the head of driver P based on an image captured by in-cabin camera 9, and estimates the position of the viewpoint of driver P based on the detected position of the head. In other words, controller 500 and in-cabin camera 9, combined, constitute one example of an estimator.

Controller 500 changes the orientation of reflective mirror 340h based on the estimated viewpoint position; thus, controller 500 adjusts the direction of first image light L10h and second image light L20h and varies the reflectance of a plurality of unit regions 121f, shown in FIG. 14, in accordance with the adjustment performed. With this adjustment, the size and the position of first reflective region D1f and second reflective region D2f are adjusted to the size and the position corresponding to the viewpoint position.

For example, when the position of the head of the driver is lowered (arrow Y81), the lower end portion of reflective mirror 340h swings rearward (arrow Y82). With this swinging, the direction of first image light L10h and second image light L20h reflected by reflective mirror 340h also shifts downward, and in accordance with this downward shift, controller 500 varies the reflectance of each of unit regions 121f of reflective member 12f. In other words, first reflective region D1f expands downward, and second reflective region D2f shrinks (arrow Y83).

On the other hand, when the position of the head of the driver is raised (arrow Y84), the lower end portion of reflective mirror 340h swings forward (arrow Y85). With this swinging, the direction of first image light L10h and second image light L20h reflected by reflective mirror 340h also shifts upward, and in accordance with this upward shift, controller 500 varies the reflectance of each of unit regions 121f of reflective member 12f. In other words, second reflective region D2f expands upward, and first reflective region D1f shrinks (arrow Y86).

In this manner, since controller 500 varies the reflectance of a plurality of unit regions 121f based on the estimated position of the viewpoint, the size of first reflective region D1f and second reflective region D2f can be adjusted in accordance with the position of the viewpoint of driver P.

Furthermore, controller 500 varies the orientation of reflective mirror 340h based on the estimated viewpoint position; thus, controller 500 adjusts the direction of first image light L10h and second image light L20h and varies the reflectance of a plurality of unit regions 121f in accordance with the adjustment performed. With this adjustment, the direction of first image light L10h and second image light L20h is adjusted in accordance with the position of the driver's viewpoint, and in accordance with this adjustment, the size of first reflective region D1f and second reflective region D2f is also adjusted.

In the case illustrated herein, the direction of first image light L10h and second image light L20h is adjusted by adjusting the orientation of reflective mirror 340h. Alternatively, the direction of first image light L10h and second image light L20h may be adjusted by adjusting the orientation of display element 330h.

### Embodiment 9

Embodiment 9 will now be described. In the case described according to Embodiment 9, a plurality of backlights are provided for a single display element.

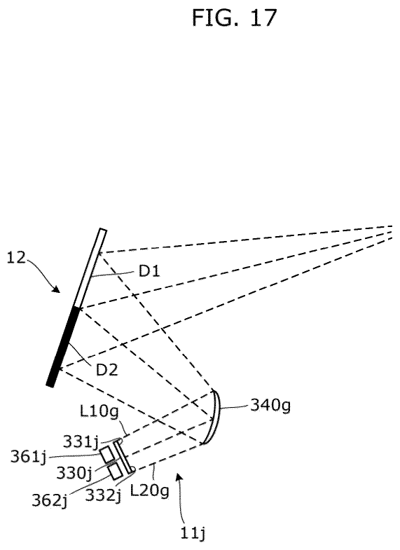

FIG. 17 is an explanatory drawing showing display device 11j according to Embodiment 9. As shown in FIG. 17, display element 330j included in display device 11j is a liquid crystal panel. First backlight 361j is disposed to the back side of first display area 331j (a first region) of display element 330j, and second backlight 362j is disposed to the back side of second display area 332j (a second region) of display element 330j. In other words, first backlight 361j faces the first region, and second backlight 362j faces the second region. First backlight 361 is a light source with a higher output power than second backlight 362j. First backlight 361j and second backlight 362j are controlled independently of each other by controller 500.

In this manner, since first backlight 361j corresponding to the first region and second backlight 362j corresponding to the second region are provided, this configuration makes it possible to install a backlight suitable for each image light. This configuration also makes it possible to reduce the amount of heat emitted from each backlight.

### Embodiment 10

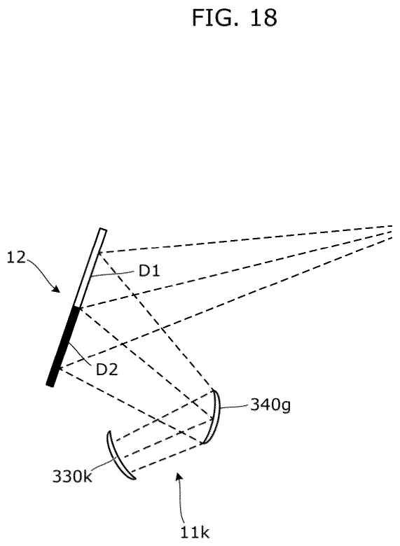

Embodiment 10 will now be described. In the case described according to Embodiment 10, a display element is curved. FIG. 18 is an explanatory drawing showing display device 11k according to Embodiment 10. As shown in FIG. 18, display element 330k included in display device 11k has a display surface that is curved in a concave shape. Since display element 330k is curved in this manner, distortion of first virtual image 101 and second virtual image 201 can be reduced.

### Embodiment 11

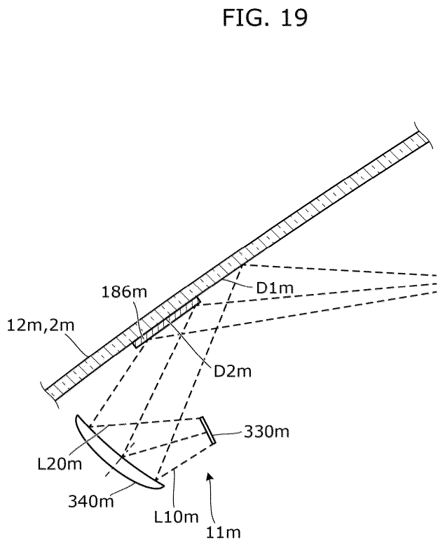

Embodiment 11 will now be described. In the case illustrated according to Embodiment 11, the reflective member is a windshield. FIG. 19 is an explanatory drawing showing display device 11m and reflective member 12m according to Embodiment 11.

Display device 11m includes display element 330m and reflective mirror 340m. Display element 330m is disposed rearward of reflective mirror 340m. Reflective mirror 340m is a concave mirror having a free-form surface. Reflective member 12m is windshield 2m. In other words, according to the present embodiment, no combiner is provided, and first image light L10m and second image light L20m reflected by reflective mirror 340m are reflected by reflective member 12m (windshield 2m). In this example, first reflective region Dim of reflective member 12m is exposed, and second reflective region D2m is laminated with reflective film 186m. Because of this reflective film 186m, the reflectance of second reflective region D2m is higher than the reflectance of first reflective region D1m. In other words, the reflectance of first reflective region D1m is lower than the reflectance of second reflective region D2m. As long as this relationship can be satisfied, both first reflective region D1m and second reflective region D2m may be laminated with a reflective film, or only first reflective region D1m may be laminated with a reflective film. At least one of first reflective region D1m or second reflective region D2m may be laminated with a liquid crystal mirror.

In this manner, since windshield 2m included in vehicle 1 is used as reflective member 12m, this configuration renders it unnecessary to provide a dedicated reflective member, and the size of the system can be reduced.

### Embodiment 12

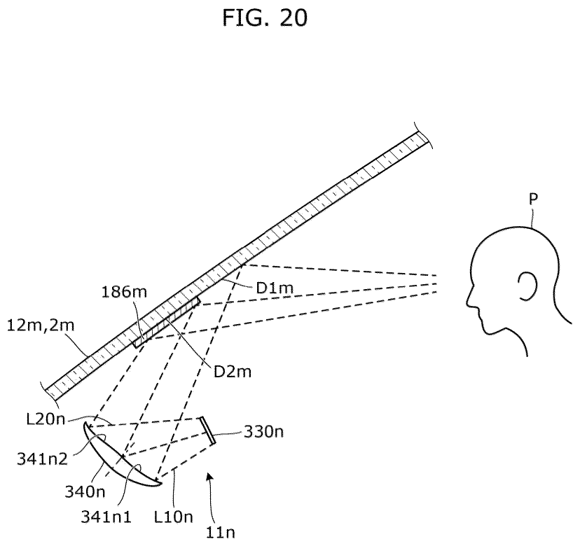

Embodiment 12 will now be described. In the case described according to Embodiment 12, the mirror surface of a reflective mirror constituted by a concave mirror is divided into two sections, and these two sections have different radii of curvature. FIG. 20 is an explanatory drawing showing display device 11n according to Embodiment 12.

Display device 11n includes display element 330n and reflective mirror 340n. Display element 330n is disposed rearward of reflective mirror 340n. Reflective mirror 340n is a concave mirror, and the radius of curvature of first divided region 341n1 corresponding to first image light L10n and the radius of curvature of second divided region 341n2 corresponding to second image light L20n differ from each other. Specifically, the radius of curvature of first divided region 341n1 is set to a value with which first virtual image 101 formed by first image light L10n becomes positioned 11 meters or more ahead of driver P. Setting this distance to such a distance makes it easier for the driver to see first virtual image 101 especially when first virtual image 101 is superposed on the road ahead. Meanwhile, the radius of curvature of second divided region 341n2 is set to a value with which second virtual image 201 formed by second image light L20n is positioned greater than or equal to 1.5 meters and less than or equal to 3 meters ahead of driver P. This configuration can keep second virtual image 201 from being displayed as if second virtual image 201 is in the vehicle body and allows the driver to see second virtual image 201 more easily.

Based on these points, first virtual image 101 and second virtual image 201 are positioned with an interval (the length of a straight line connecting the upper end of first virtual image 101 and the lower end of second virtual image 201) of 8 meters or more, as viewed in side view. Herein, one of the reasons why this interval is set to 8 meters or more is that, since the smallest distance from driver P to first virtual image 101 is 11 meters and the distance from driver P to second virtual image 201 is 3 meters at maximum, 8 meters, which is the difference between these two distances, comes out as the smallest distance. The configuration described above makes it possible to display first virtual image 101 or second virtual image 201 in accordance with the actual position of an object. Herein, the radius of curvature at the border between first divided region 341n1 and second divided region 341n2 may be set such that the lower end of first virtual image 101 and the upper end of second virtual image 201 look continuous in the up-down direction.

### OTHERS

Thus far, display systems according to one or more aspects of the present disclosure have been described based on the embodiments, but these embodiments do not limit the present disclosure. Unless departing from the spirit of the present disclosure, an embodiment obtained by making various modifications that a person skilled in the art can conceive of to the foregoing embodiments or an embodiment obtained by combining constituent elements in different embodiments may also be encompassed within the scope of the one or more aspects of the present disclosure.

For example, although cases in which reflective member 12 is a transparent member have been illustrated according to the foregoing embodiments, a reflective member may be a non-transparent member. Herein, at least the part of the reflective member that corresponds to a first reflective region may be constituted by a reflective member.

### SUPPLEMENTARY NOTES

Through the foregoing description of the embodiments and so forth, the following techniques are disclosed.

### Technique 1

A display system comprising:
a display device that projects first image light forming a first virtual image and second image light forming a second virtual image;
a controller that controls the display device; and
a reflective member that reflects the first image light and the second image light, the reflective member positioning the first virtual image and the second virtual image ahead of a user and ahead of the reflective member, wherein
in the reflective member, a reflectance of a first reflective region that reflects the first image light and a reflectance of a second reflective region that reflects the second image light differ from each other.

### Technique 2

The display system according to Technique 1, wherein
the first reflective region is disposed above the second reflective region.

### Technique 3

The display system according to Technique 2, wherein
the reflectance of the first reflective region is lower than the reflectance of the second reflective region.

### Technique 4

The display system according to Technique 1, wherein
at least one of the reflectance of the first reflective region or the reflectance of the second reflective region is variable.

### Technique 5

The display system according to Technique 4, wherein
the controller includes an equalizing mode that causes the reflectance of the first reflective region and the reflectance of the second reflective region to coincide with each other.

### Technique 6

The display system according to Technique 5, wherein
the display device includes two display elements that each form image light of a different polarization, and
when the equalizing mode is being executed, the controller, by controlling the display device, causes the image light to be projected from only one of the two display elements toward the first reflective region and the second reflective region.

### Technique 7

The display system according to any one of Techniques 4 to 6, wherein
the reflective member includes a plurality of unit regions arrayed in a regular pattern, and
reflectances of the plurality of unit regions are variable independently of each other.

### Technique 8

The display system according to Technique 7, further comprising:
an estimator that estimates a viewpoint position of the user, wherein
the controller varies the reflectances of the plurality of unit regions, based on the viewpoint position estimated by the estimator.

### Technique 9

The display system according to Technique 8, further comprising:
at least one optical element for forming the first image light and the second image light, wherein
based on the viewpoint position estimated by the estimator, the controller makes an adjustment to directions of the first image light and the second image light by changing an orientation of the at least one optical element, and varies the reflectances of the plurality of unit regions in accordance with the adjustment.

### Technique 10

The display system according to any one of Techniques 1 to 9, wherein
the display device includes a first display element that forms the first image light, and a second display element that forms the second image light.

### Technique 11

The display system according to any one of Techniques 1 to 9, wherein
the display device includes a display element that forms the first image light and the second image light.

### Technique 12

The display system according to Technique 11, wherein
the display element is a liquid crystal panel, and
the display device includes a first backlight that faces a first region of the liquid crystal panel where the liquid crystal panel forms the first image light, and a second backlight that faces a second region of the liquid crystal panel where the liquid crystal panel forms the second image light.

### Technique 13

The display system according to Technique 11 or 12, wherein
the display element is curved.

### Technique 14

The display system according to any one of Techniques 1 to 13, wherein
the reflective member is a transparent member.

### Technique 15

The display system according to any one of Techniques 1 to 14, wherein
the reflective member is a windshield included in a vehicle.

### Technique 16

The display system according to any one of Techniques 1 to 15, wherein
the first reflective region and the second reflective region are at different inclinations, as viewed in side view.

### Technique 17

The display system according to any one of Techniques 1 to 16, wherein
the first virtual image and the second virtual image are positioned with an interval of no more than 2 diopters, as viewed in side view.

### Technique 18

The display system according to any one of Techniques 1 to 16, wherein
the first virtual image and the second virtual image are positioned with an interval of 8 meters or more, as viewed in side view.

### Technique 19

The display system according to any one of Techniques 1 to 18, wherein
at least one of the first reflective region or the second reflective region of the reflective member is laminated with a reflective film including at least one layer.

### Technique 20

The display system according to any one of Techniques 1 to 19, wherein
a mark to be displayed over the first virtual image and the second virtual image is formed continuously in the first virtual image and the second virtual image.

### Technique 21

The display system according to any one of Techniques 1 to 20, wherein
the reflectance of the first reflective region is lower than the reflectance of the second reflective region, the first virtual image displays first information, and
the second virtual image displays second information having a larger amount of information than the first information.

While various embodiments have been described herein above, it is to be appreciated that various changes in form and detail may be made without departing from the spirit and scope of the present disclosure as presently or hereafter claimed.

### FURTHER INFORMATION ABOUT TECHNICAL BACKGROUND TO THIS APPLICATION

The disclosures of the following patent applications including specification, drawings, and claims are incorporated herein by reference in their entirety: Japanese Patent Application No. 2024-096394 filed on Jun. 14, 2024.

### INDUSTRIAL APPLICABILITY

The present disclosure can be used in a display system for displaying an image.

1. A display system comprising:
a display device that projects first image light forming a first virtual image and second image light forming a second virtual image;
a controller that controls the display device; and
a reflective member that reflects the first image light and the second image light, the reflective member positioning the first virtual image and the second virtual image ahead of a user and ahead of the reflective member, wherein
in the reflective member, a reflectance of a first reflective region that reflects the first image light and a reflectance of a second reflective region that reflects the second image light differ from each other.

2. The display system according to claim 1, wherein
the first reflective region is disposed above the second reflective region.

3. The display system according to claim 2, wherein
the reflectance of the first reflective region is lower than the reflectance of the second reflective region.

4. The display system according to claim 1, wherein
at least one of the reflectance of the first reflective region or the reflectance of the second reflective region is variable.

5. The display system according to claim 4, wherein
the controller includes an equalizing mode that causes the reflectance of the first reflective region and the reflectance of the second reflective region to coincide with each other.

6. The display system according to claim 5, wherein
the display device includes two display elements that each form image light of a different polarization, and
when the equalizing mode is executed, the controller, by controlling the display device, causes the image light to be projected from only one of the two display elements toward the first reflective region and the second reflective region.

7. The display system according to claim 4, wherein
the reflective member includes a plurality of unit regions arrayed regularly, and
reflectances of the plurality of unit regions are variable independently of each other.

8. The display system according to claim 7, further comprising:
an estimator that estimates a viewpoint position of the user, wherein
the controller varies the reflectances of the plurality of unit regions, based on the viewpoint position estimated by the estimator.

9. The display system according to claim 8, further comprising:
at least one optical element for forming the first image light and the second image light, wherein
based on the viewpoint position estimated by the estimator, the controller makes an adjustment to directions of the first image light and the second image light by changing an orientation of the at least one optical element, and varies the reflectances of the plurality of unit regions in accordance with the adjustment.

10. The display system according to claim 1, wherein
the display device includes a first display element that forms the first image light, and a second display element that forms the second image light.

11. The display system according to claim 1, wherein
the display device includes a display element that forms the first image light and the second image light.

12. The display system according to claim 11, wherein
the display element is a liquid crystal panel, and
the display device includes a first backlight that faces a first region of the liquid crystal panel where the liquid crystal panel forms the first image light, and a second backlight that faces a second region of the liquid crystal panel where the liquid crystal panel forms the second image light.

13. The display system according to claim 11, wherein
the display element is curved.

14. The display system according to claim 1, wherein
the reflective member is a transparent member.

15. The display system according to claim 1, wherein
the first reflective region and the second reflective region are at different inclinations, as viewed in side view.

16. The display system according to claim 1, wherein
the first virtual image and the second virtual image are positioned with an interval of no more than 2 diopters, as viewed in side view.

17. The display system according to claim 1, wherein
the first virtual image and the second virtual image are positioned with an interval of 8 meters or more, as viewed in side view.

18. The display system according to claim 1, wherein
at least one of the first reflective region or the second reflective region of the reflective member is laminated with a reflective film including at least one layer.

19. The display system according to claim 1, wherein
a mark to be displayed over the first virtual image and the second virtual image is formed continuously in the first virtual image and the second virtual image.

20. The display system according to claim 1, wherein
the reflectance of the first reflective region is lower than the reflectance of the second reflective region,
the first virtual image displays first information, and
the second virtual image displays second information having a larger amount of information than the first information.
